(19) United States
(12) Patent Application Publication
(10) Pub. No.: US 2026/0245064 A1
(43) Pub. Date: Aug. 20, 2026

(54) METHOD AND APPARATUS FOR ELECTRONIC PAYMENT AUTHENTICATION SERVICE USING ACCESSORY ELECTRONIC DEVICE

(71) Applicant: Samsung Electronics Co., Ltd., Suwon-si (KR)

(72) Inventors: Hanseong JUNG, Suwon-si (KR); Insoo LEE, Suwon-si (KR); Namin KIM, Suwon-si (KR); Sunhwa PARK, Suwon-si (KR); Heeyoung JEONG, Suwon-si (KR)

(21) Appl. No.: 19/646,875

(22) Filed: Apr. 14, 2026

Related U.S. Application Data
(63) Continuation of application No. PCT/KR2024/096379, filed on Oct. 17, 2024.

(30) Foreign Application Priority Data
Oct. 23, 2023 (KR) 10-2023-0142376
Dec. 19, 2023 (KR) 10-2023-0186205

(51) Int. Cl. G06Q 20/32; G06Q 20/40

(52) U.S. Cl. CPC G06Q 20/321; G06Q 20/4012; G06Q 20/40145; G06Q 20/409

(57) ABSTRACT

An electronic device is provided. The electronic device includes a communication module comprising at least one communication circuit, memory, including one or more storage media, storing instructions, and one or more processors communicatively coupled to the communication module and the memory, wherein the instructions, when executed by the one or more processors individually or collectively, cause the electronic device to, based on receiving information on detection of wearing of an accessory electronic device registered in the memory through the communication module while the electronic device is paired with the accessory electronic device, generate a first authentication token through a device manager associated with the accessory electronic device, and transmit the generated first authentication token to an electronic payment application stored in the memory, upon receiving an electronic payment service request from the electronic payment application, request an authentication token from the accessory electronic device to receive a second authentication token from the accessory electronic device or the device manager, in a case where the first authentication token stored in the electronic payment application is identical to the second authentication token transmitted from the accessory electronic device or the device manager, request user authentication for electronic payment to the accessory electronic device, and determine whether the user authentication is successful based on user authentication information received from the accessory electronic device.

### CROSS-REFERENCE TO RELATED APPLICATION(S)

This application is a continuation application, claiming priority under 35 U.S.C. § 365(c), of an International application No. PCT/KR2024/096379, filed on Oct. 17, 2024, which is based on and claims the benefit of a Korean patent application number 10-2023-0142376, filed on Oct. 23, 2023, in the Ministry of Intellectual Property (MOIP), and of a Korean patent application number 10-2023-0186205, filed on Dec. 19, 2023, in the Ministry of Intellectual Property (MOIP), the disclosure of each of which is incorporated by reference herein in its entirety.

### BACKGROUND

### 1. Field

The disclosure relates to a method and apparatus for an electronic payment authentication service using an accessory electronic device.

### 2. Description of Related Art

With the widespread adoption of the Internet, interest is growing in technologies that enable payments using users' electronic devices, not only offline but also online. For example, electronic devices support electronic payment services/functions (e.g., simple payment) that allow payments to be made upon the completion of authentication using the electronic device (e.g., password entry or the like).

Since electronic payment services are available at offline merchants as well as online, they are becoming increasingly popular among many users.

In order for the electronic payment services to execute payment functions, an authentication process must be preceded. Authentication methods may include, for example, personal identification number (PIN) authentication, such as entering a password on a keypad, or biometric authentication using biometric information such as fingerprints or iris patterns.

The above information is presented as background information only to assist with an understanding of the disclosure. No determination has been made, and no assertion is made, as to whether any of the above might be applicable as prior art with regard to the disclosure.

### SUMMARY

The authentication process for electronic payment services may necessarily require the user to operate an electronic device (e.g., operating the electronic device screen/authentication gestures). However, users may experience inconvenience when using electronic payment services in situations where it is difficult to operate the electronic device (e.g., when the electronic device is stored in a bag, or when the electronic device is being used for other purposes).

Accordingly, technologies are being developed to support electronic payment services by utilizing other devices (e.g., accessory electronic devices or wearable electronic devices) that communicate with the electronic device.

Aspects of the disclosure are to address at least the above-mentioned problems and/or disadvantages and to provide at least the advantages described below. Accordingly, an aspect of the disclosure is to provide a payment authentication service method and device that allow users to use electronic payment services more conveniently by replacing the user authentication process with an accessory electronic device that interfaces with the electronic device in situations where it is difficult to operate the electronic device during electronic payment services.

Additional aspects will be set forth in part in the description which follows and, in part, will be apparent from the description, or may be learned by practice of the presented embodiments.

In accordance with an aspect of the disclosure, an electronic device is provided. The electronic device includes a communication module, memory, including one or more storage media, storing instructions, and one or more processors communicatively coupled to the communication module and the memory, wherein the instructions, when executed by the one or more processors individually or collectively, cause the electronic device to, based on receiving information on detection of wearing of an accessory electronic device registered in the memory through the communication module while the electronic device is paired with the accessory electronic device, generate a first authentication token through an accessory electronic device manager, based on detection of wearing of an accessory electronic device when the electronic device is paired with the accessory electronic device, and transmit the generated first authentication token to an electronic payment application stored in the memory, upon receiving an electronic payment service request from the electronic payment application, request an authentication token from the accessory electronic device to receive a second authentication token from the accessory electronic device or the accessory electronic device manager, in a case where the first authentication token stored in the electronic payment application is identical to the second authentication token transmitted from either the accessory electronic device or the accessory electronic device manager, request user authentication for electronic payment from the accessory electronic device, and determine whether user authentication is successful based on user authentication information received from the accessory electronic device.

In accordance with another aspect of the disclosure, an accessory electronic device is provided. The accessory electronic device includes at least one sensor, a communication module, memory, including one or more storage media, storing instructions, and one or more processors communicatively coupled to the at least one sensor, the communication module, and the memory, wherein the instructions, when executed by the one or more processors individually or collectively, cause the accessory electronic device to, based on pairing with an electronic device through the communication module and detection of wearing of the accessory electronic device through the at least one sensor, generate a first authentication token, store the generated first authentication token in the memory, and transmit the first authentication token to the electronic device through the communication module, upon receiving a second authentication token for an electronic payment request from the electronic device, provide a notification of user authentication request information for the electronic payment request, based on the first authentication token stored in the memory being identical to the second authentication token transmitted from the electronic device, determine whether user authentication is successful based on user authentication information detected through the at least one sensor, transmit user authentication success information for the electronic payment request to the electronic device through the communication module in a case where user authentication is successful, or transmit user authentication failure information to the electronic device through the communication module in a case where user authentication fails.

In accordance with another aspect of the disclosure, a method for an electronic payment service of an electronic device using an accessory electronic device is provided. The electronic payment service method includes generating a first authentication token through a device manager associated with the accessory electronic device, based on pairing between the accessory electronic device and an electronic device and receiving information on detection of wearing of the accessory electronic device from the accessory electronic device, transmitting the generated first authentication token to an electronic payment application upon receiving an electronic payment service request from the electronic payment application, requesting an authentication token from the accessory electronic device to receive a second authentication token from the accessory electronic device or the device manager, in a case where the first authentication token stored in the electronic payment application is identical to the second authentication token transmitted from the accessory electronic device or the device manager, requesting user authentication for electronic payment from the accessory electronic device through the communication module, and determining whether user authentication is successful based on user authentication information received from the accessory electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include generating a first authentication token through a device manager associated with the accessory electronic device, based on pairing between the accessory electronic device and an electronic device and receiving information on detection of wearing of the accessory electronic device from the accessory electronic device, transmitting the generated first authentication token to an electronic payment application, upon receiving an electronic payment service request from the electronic payment application, requesting an authentication token from the accessory electronic device to receive a second authentication token from either the accessory electronic device or the device manager, in a case where the first authentication token stored in the electronic payment application is identical to the second authentication token transmitted from either the accessory electronic device or the device manager, requesting user authentication for electronic payment from the accessory electronic device, and determining whether user authentication is successful based on user authentication information received from the accessory electronic device.

In accordance with another aspect of the disclosure, an electronic device is provided. The electronic device includes a computer-readable recording medium storing a program for implementing an electronic payment authentication service method using an accessory electronic device.

An electronic device and method according to various embodiments provide a system that enables electronic payment without operating the electronic device by completing user authentication using the accessory electronic device through comparison of authentication tokens via communication with the accessory electronic device when using an electronic payment service.

An electronic device and method according to various embodiments implement the success or failure of user authentication for electronic payment depending on whether the accessory electronic device is worn or removed.

Since the accessory electronic device does not contain actual payment information, an electronic device and method according to various embodiments prevent the misuse of electronic payment in the event of loss of the accessory electronic device.

An electronic device and method according to various embodiments perform a simple payment service using the accessory electronic device during offline electronic payment.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates the configuration of an accessory electronic device according to an embodiment of the disclosure;

FIG. 3 illustrates an example of an authentication means configuration screen related to an electronic payment service for an electronic device according to an embodiment of the disclosure;

FIG. 4 is a view illustrating an online payment system using an electronic device and an accessory electronic device according to an embodiment of the disclosure;

FIGS. 5A and 5B illustrate a method of configuring an accessory electronic device as an authentication means for an electronic payment service of an electronic device according to various embodiments of the disclosure;

FIGS. 6A and 6B illustrate an electronic payment authentication service method for an electronic device using an accessory electronic device according to various embodiments of the disclosure;

FIGS. 7A and 7B illustrate an electronic payment authentication service method for an electronic device using an accessory electronic device according to various embodiments of the disclosure;

FIG. 8 illustrates an example of an authentication means configuration screen related to an electronic payment service for an electronic device according to an embodiment of the disclosure;

FIG. 9 is a view illustrating an offline payment system using an electronic device and an accessory electronic device according to an embodiment of the disclosure;

FIG. 10 illustrates a method of configuring an accessory electronic device as an authentication and payment means for an electronic payment service of an electronic device according to an embodiment of the disclosure;

FIG. 11 illustrates an offline electronic payment service method of an electronic device using an accessory electronic device according to an embodiment of the disclosure;

FIG. 12 illustrates an offline electronic payment service method of an electronic device using an accessory electronic device according to an embodiment of the disclosure; and

FIG. 13 illustrates an example of an electronic payment service method of an electronic device using an accessory electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. The electronic device according to the embodiments disclosed herein is not limited to the above-described devices.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

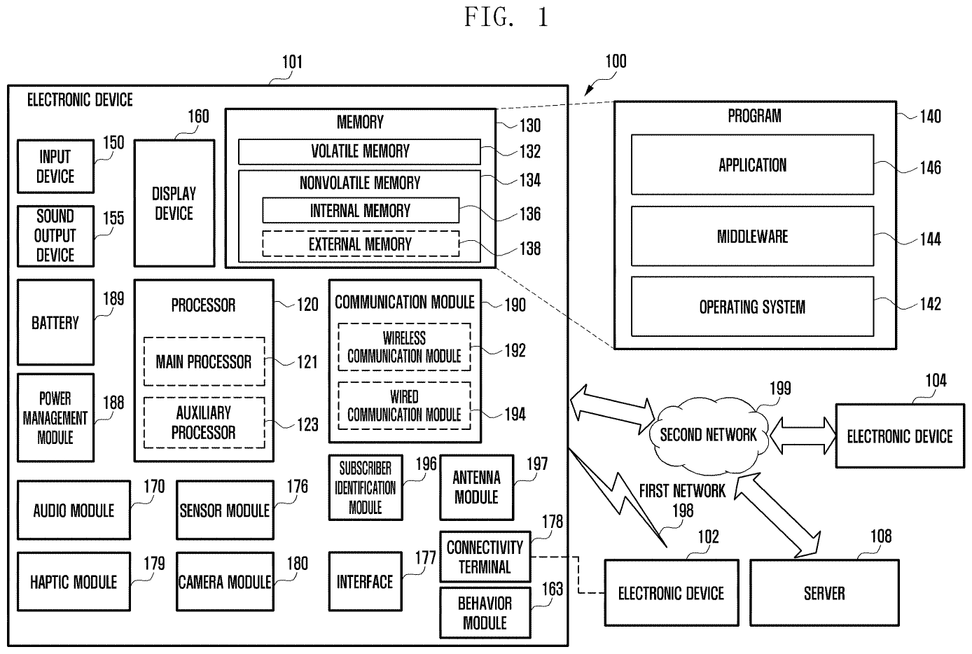

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, the electronic device 101 may include a communication module 190. According to an embodiment, the electronic device 101 may include memory 130 configured to store executable instructions and a processor 120 configured to access the memory and execute the instructions. According to an embodiment, the instructions may cause the electronic device 101 to, based on detection of wearing of the accessory electronic device 201 while the electronic device 101 is paired with the accessory electronic device 201, generate a first authentication token through a device manager associated with the accessory electronic device 201. According to an embodiment, the instructions may cause the electronic device 101 to transmit the generated first authentication token to an electronic payment application stored in the memory 130. According to an embodiment, the instructions may cause the electronic device 101 to, upon receiving an electronic payment service request from the electronic payment application, request an authentication token from the accessory electronic device 201 to receive a second authentication token from the accessory electronic device 201 or the device manager. According to an embodiment, the instructions may cause the electronic device 101 to, in a case where the first authentication token stored in the electronic payment application is identical to the second authentication token transmitted from the accessory electronic device 201 or the device manager, request user authentication for electronic payment from the accessory electronic device 201. According to an embodiment, the instructions may cause the electronic device 101 to determine whether user authentication is successful based on user authentication information received from the accessory electronic device 201.

According to an embodiment, the memory 130 may further include instructions that cause the electronic device 101 to, based on detection of removal of the accessory electronic device 201 using the device manager, generate a third authentication token and update the first authentication token to the third authentication token.

According to an embodiment, the memory 130 may further include an instruction that causes the electronic device 101 to display authentication failure information on a display via the electronic payment application in a case where the first authentication token stored in the electronic payment application differs from the second authentication token transmitted from the device manager.

According to an embodiment, the memory 130 may further include an instruction that causes the electronic device 101 to, in a case where the first authentication token stored in the electronic payment application differs from the second authentication token transmitted from the device manager, stop the user authentication requested to the accessory electronic device 201 and request user authentication using the electronic payment application.

According to an embodiment, the first authentication token and the second authentication token may include at least one of token data, device identification information, and personal identification information.

According to an embodiment, the user authentication may be one of biometric information or a password.

According to an embodiment, in a case where the device manager is programmed in the memory of the electronic device, the memory 130 may further include an instruction that causes the electronic device 101 to transmit the generated first authentication token to the electronic payment application and the accessory electronic device, and compare the first authentication token with the second authentication token through the electronic payment application or the device manager to determine whether they are identical.

According to an embodiment, in a case where the device manager is programmed in the memory 130 of the electronic device 101, the memory 130 may further include instructions that cause the electronic device 101 to receive the first authentication token or the third authentication token generated through the device manager from the accessory electronic device 201 via the communication module 190, and transmit the first authentication token or the third authentication token transmitted from the accessory electronic device 201 to the electronic payment application via the communication module 190.

According to an embodiment, the memory 130 may further include instructions that cause the electronic device 101 to proceed with the electronic payment service in a case where the user authentication information transmitted from the accessory electronic device 201 is identical to the user authentication information stored in the electronic device 101.

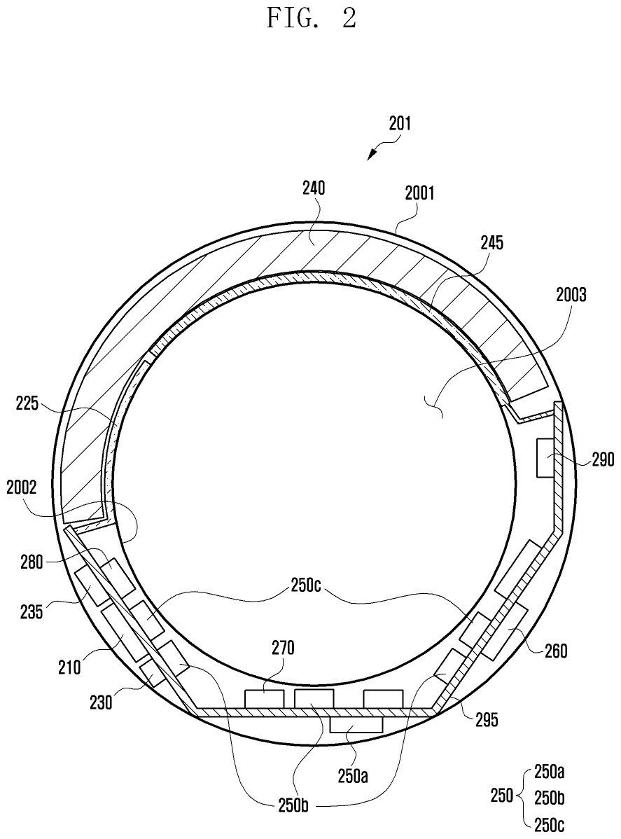

FIG. 2 illustrates the configuration of an accessory electronic device according to an embodiment of the disclosure.

Referring to FIG. 2, according to an embodiment, an accessory electronic device 201 that interfaces with an electronic device 101 may refer to an electronic device that supports biometric-information sensing functions, touch functions, and wireless communication functions, and is capable of being worn on a user's body. The accessory electronic device 201 may also be referred to as a wearable electronic device.

Although the accessory electronic device 201 illustrated in FIG. 2 is depicted as a ring type (e.g., a smart ring) worn on the user's finger, it is not limited thereto and may be implemented as other types of accessory electronic devices, such as a watch type (e.g., a smart watch) or a band type (e.g., a smart band).

The accessory electronic device 201 according to an embodiment may include an annular first housing 2001 (e.g., an outer ring housing, a first ring housing, or a first housing portion) and an annular second housing 2002 (e.g., an inner ring housing, a second ring housing, or a second housing portion) coupled to the first housing 2001 and including an opening 2003. The opening 2003 may be formed to a size that allows a user's finger to be inserted. For example, the first housing 2001 may be formed of a material that withstands external impacts or scratches, such as metal, ceramic, or stainless steel. The first housing 2001 may undergo a separate fixing or coating process for color implementation. For example, the second housing 2002 may be formed of the same material as the first housing 2001, or of a material such as a molding material, plastic, or glass for sensing. The second housing 2002 may have a metal material formed in at least a portion for biometric measurement.

The accessory electronic device 201 according to an embodiment may include a processor 210, memory 220, an antenna 225, a communication module 235, a battery 240, a charging interface 245, at least one biometric sensor 250, a touch sensor 260, an inertial sensor 270, a temperature sensor 280, and/or a power management integrated circuit (PMIC) 290, which are disposed in the space between the first housing 2001 and the second housing 2002. Some components may be disposed on a substrate 295 (e.g., flexible printed circuit board (FPCB)) that has flexibility to correspond to the curvature of the accessory electronic device 201.

According to some embodiments, the accessory electronic device 201 may further include other components (e.g., a display, an ultrasonic sensor, and an audio output device) in addition to the illustrated components.

The communication module 235 according to an embodiment may include various hardware and/or software configurations to support wireless communication with an external electronic device (hereinafter, the electronic device 101 in FIG. 1). The wearable electronic device 201 may transmit and receive various data or control commands to and from the electronic device 101 via wired or wireless communication through the communication module 235. In an embodiment, the communication module 235 may support short-range wireless communication. For example, short-range wireless communication includes, but is not limited to, at least one of Bluetooth, Bluetooth low energy (BLE), ZigBee, ANT+, Wi-Fi, cellular (long term evolution (LTE), 5G, sixth-generation (6G), or narrowband (NB)-IoT), near-field communication (NFC), radio frequency identification (RFID), ultra-wide band UWB), global navigation satellite system (GNSS), and/or magnetic secure transmission (MST). According to some embodiments, the communication module 235 may be implemented to be integrated with the processor 210.

The antenna 225 according to an embodiment may be connected to the communication module 235 via the substrate 295. The wearable electronic device 201 may transmit or receive communication signals/data to or from an external source through the antenna 225. The antenna 225 may include a single or multiple antennas. In some embodiments, a part (e.g., a metal member) of the first housing 2001 may be designed to be used as the antenna 225.

The battery 240 according to an embodiment may be formed in a curved shape to have a curvature corresponding to the curvature of the space between the first housing 2001 and the second housing 2002. For example, the battery 240 may have a plurality of battery packs arranged separately. The battery 240 may be connected to the charging interface 245.

The charging interface 245 according to an embodiment may be electrically connected to the PMIC 290 mounted on the substrate 295 via the substrate 295. For example, the charging interface 245 may support wired charging (terminal) or wireless charging (WPC or NFC) methods for charging.

According to an embodiment, at least one biometric sensor 250 may obtain various biometric information of a user using an optical signal. For example, the biometric sensor 250 may be a photoplethysmogram (PPG) sensor or optical sensor capable of obtaining various biometric information, such as heart rate and blood circulation, by measuring a plethysmogram according to an optical signal, but is not limited thereto. The biometric sensor 250 may obtain biometric information such as heart rate (HR), blood pressure, saturation of percutaneous oxygen (SpO₂), galvanic skin response (GSR), electrocardiography (ECG), blood flow velocity, and/or bioelectrical impedance, but is not limited thereto.

According to some embodiments, the biometric sensor 250 may include a fingerprint sensor.

The biometric sensor 250 according to an embodiment may include a sensor controller 250a, a plurality of emitters 250b that output optical signals, and a plurality of receivers 250c that receive optical signals. The emitter 250b may include a light-emitting element that emits light of various wavelengths or colors (e.g., Green, Red) to measure biometric signals. For example, the emitter 250b may be formed as at least one of a light-emitting diode (LED), a laser diode (LD), an infrared (IR) diode, and a VCSEL. For example, the receiver 250c may be formed as a photodiode (PD) or a complementary metal-oxide-semiconductor (CMOS) camera. The receiver 250c may convert the received optical signal through an analog-to-digital converter (ADC) and store it in the processor 210 or memory 220. The sensor controller 250a may control the emitter 250b and the receiver 250c.

The touch sensor 260 according to an embodiment may detect a touch signal from a user touching the wearable electronic device 201. The touch sensor 260 may be formed in at least one of, for example, pressure, capacitive, optical, or ultrasonic methods.

According to some embodiments, the touch sensor 260 may be omitted.

The inertial sensor 270 according to an embodiment may obtain movement information of the wearable electronic device 201. For example, the inertial sensor 270 may detect motion, gesture, impact, posture, and/or activity (e.g., sedentary, moving, or sports). For example, the inertial sensor 270 may be formed as a 3-axis accelerometer, but is not limited thereto, and may be formed as a 6-axis sensor including an accelerometer and a gyroscope.

The temperature sensor 280 according to an embodiment may measure the temperature of a user's body or a component (e.g., an electronic component) included in the wearable electronic device 201. The temperature sensor 280 may be formed in a contact or non-contact manner and may vary depending on the design. For example, the wearable electronic device 201 may use the temperature information recorded through the temperature sensor 280 to record the same in the memory or, under the control of the processor, to measure the user's body temperature, estimate the skin temperature, or estimate situational awareness.

The PMIC 290 according to an embodiment may manage power delivered from the battery 240 to the respective components of the wearable electronic device 201.

The memory 220 according to an embodiment may store various instructions capable of being executed by the processor 210. Such instructions may include control commands, such as arithmetic and logical operations, data transfer, or input/output, which may be processed by the processor 210.

The processor 210 according to an embodiment is configured to perform operations or data processing regarding the control and/or communication of each component of the accessory electronic device 201, and may be formed as one or more processors. There is no limitation to the operation and data processing functions that the processor 210 may implement on the accessory electronic device 201, but in this document, the processor may process various operations to support an electronic payment service related to user authentication required for an electronic payment service in conjunction with the electronic device 101.

The accessory electronic device 201 according to an embodiment may include at least one sensor 250, 270, or 280. The accessory electronic device 201 according to an embodiment may include a communication module 230. The accessory electronic device 201 according to an embodiment may include memory 220 that stores executable instructions and a processor 210 that accesses the memory 220 to execute the instructions. The instructions according to an embodiment may cause the accessory electronic device 201, when paired with the electronic device 101 through the communication module, to generate a first authentication token, based on the detection of the accessory electronic device 201 being worn, store the generated first authentication token in the memory 220, and simultaneously transmit it to the electronic device 101 through the communication module 230. The instructions according to an embodiment may cause the accessory electronic device 201, when a second authentication token for an electronic payment request is received from the electronic device 101, to provide a notification of user authentication request information for the electronic payment request, based on the first authentication token stored in the memory 220 being identical to the second authentication token transmitted from the electronic device. The instructions according to an embodiment may cause the accessory electronic device 201 to determine whether user authentication is successful based on user authentication information detected by and received from the at least one sensor. The instructions according to an embodiment may cause the accessory electronic device 201 to transmit user authentication success information for the electronic payment request to the electronic device 101 via the communication module 230 when the user authentication is successful, or transmit user authentication failure information for the electronic payment request to the electronic device 101 via the communication module 230 when the user authentication fails.

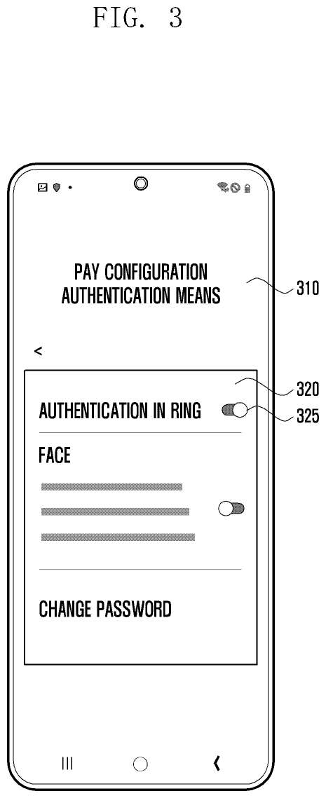

FIG. 3 illustrates an example of an authentication means configuration screen related to an electronic payment service for an electronic device according to an embodiment of the disclosure.

Referring to FIG. 3, an electronic device 101 according to an embodiment may support a function of pre-configuration (or initial registration) to use an accessory electronic device 201 as a user authentication means for an electronic payment service.

According to an embodiment, the electronic device 101 may display a configuration user interface (UI) screen 310 related to an authentication means for an electronic payment service on a display (e.g., the display module 160 in FIG. 1) as illustrated. The electronic device 101 may provide a function of using an external electronic device (e.g., the accessory electronic device 201 in FIG. 2) instead of the electronic device 101 during an electronic payment service. The configuration UI screen 310 may be used to enable or disable the function of user authentication using the accessory electronic device 201 as an authentication means. For example, the configuration UI screen 310 may include an item 320 for selecting the accessory electronic device 201 as an authentication means, and a toggle item 325 for enabling or disabling it. In the example in FIG. 3, items such as a face or password are included as authentication means, but depending on the case, configuration for other authentication means such as fingerprints, patterns, or irises may also be included.

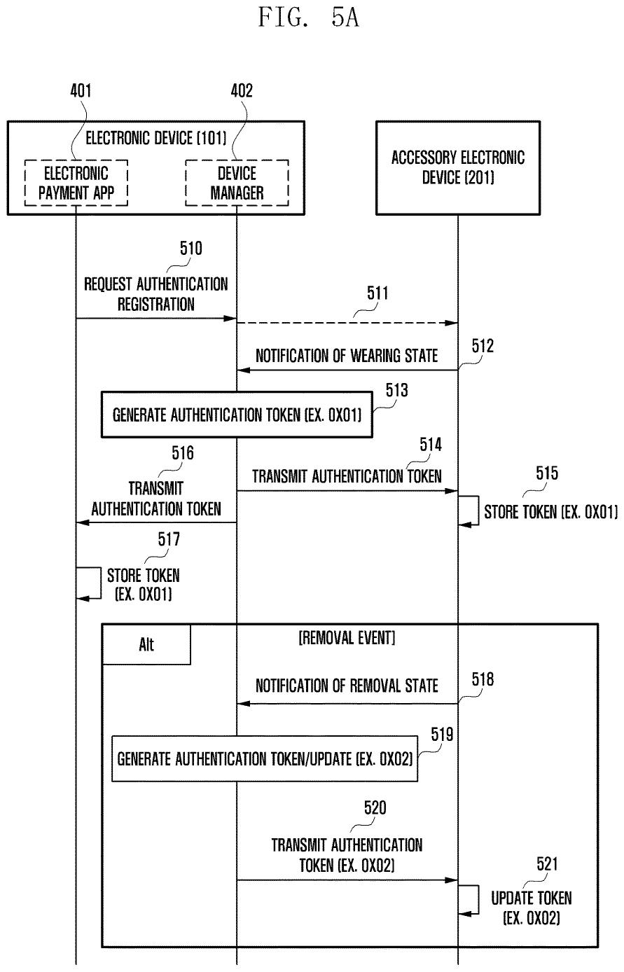

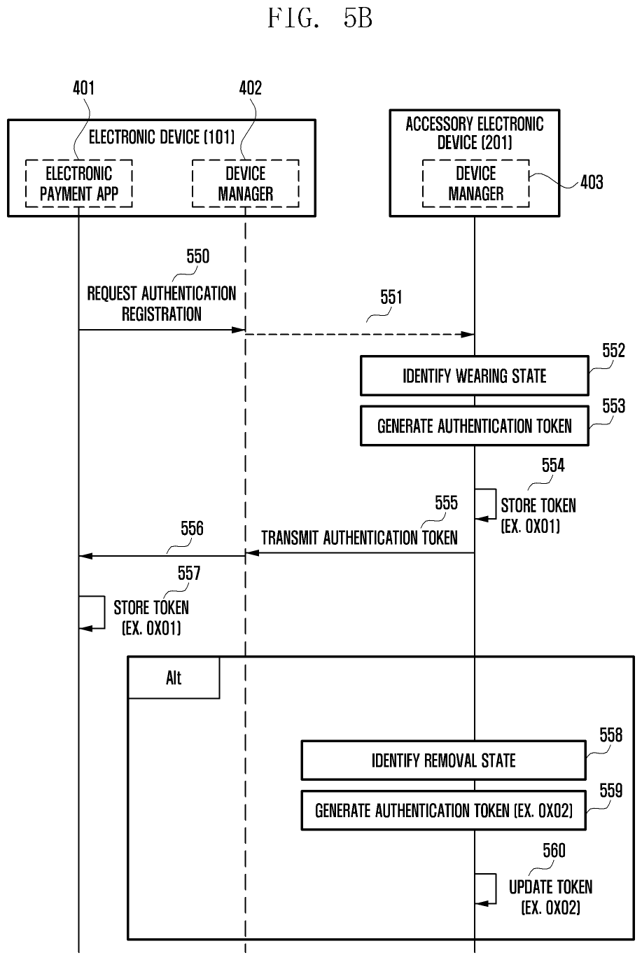

According to an embodiment, when the accessory electronic device 201 is configured as an authentication means for an electronic payment service through the configuration UI screen 310 shown in FIG. 3, the electronic device 101 may perform an authentication registration and token exchange procedure in FIGS. 5A and 5B whenever the accessory electronic device 201 is paired (e.g., Bluetooth connection). The authentication registration and token exchange procedure will be described below with reference to FIGS. 5A and 5B.

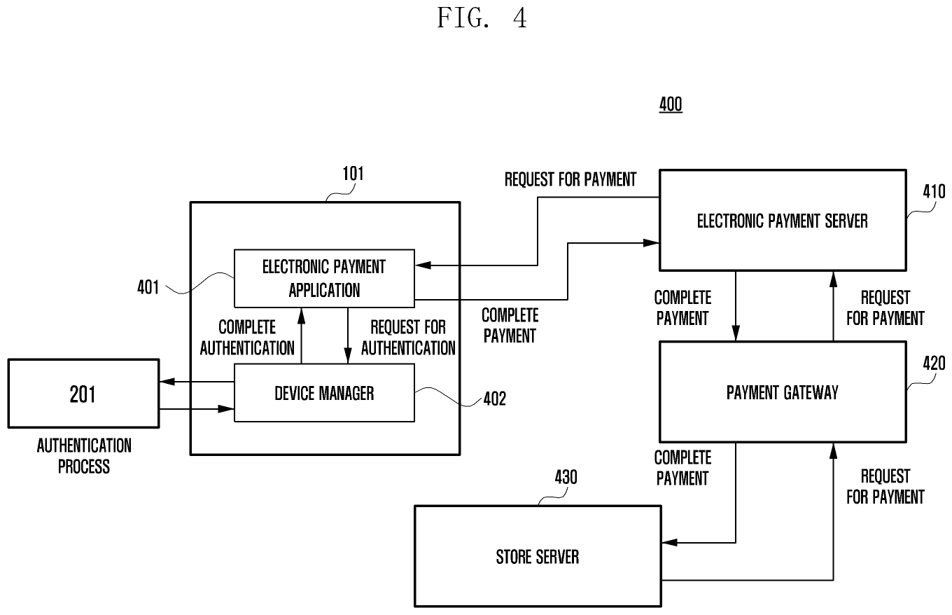

FIG. 4 is a view illustrating an online payment system using an electronic device and an accessory electronic device according to an embodiment of the disclosure.

Referring to FIG. 4, according to an embodiment, an online payment system 400 using an accessory electronic device 201 as an authentication means may include an electronic device 101, an accessory electronic device 201, an app server (e.g., application server) 410, a payment gateway 420, and/or a store server (e.g., online store) 430.

The electronic device 101 may include an electronic payment application (or payment app, hereinafter referred to as electronic payment app) 401 that supports an electronic payment service, and/or a device manager 402 that controls/manages the accessory electronic device 201.

According to some embodiments, the device manager 402 may operate in conjunction with the electronic payment app 401.

For example, the user of the electronic device 101 may access the store server 430 through a store app to purchase goods online. After selecting goods to purchase through the store app, the user of the electronic device 101 may select an electronic payment service (e.g., simple payment or Pay payment) as a payment means for the purchase.

For example, the store server 430 may transmit a payment request including information of the electronic device 101 requesting payment and payment information to the payment gateway 420 (or payment server) (e.g., card company server). The payment gateway 420 may transmit the payment request to the app server 410 (e.g., Samsung Pay server or Naver Pay server) that provides an electronic payment service.

The app server 410 may transmit the payment request to the electronic payment app 401 of the electronic device 101 to identify the purchase payment from the electronic device 101.

The electronic payment app 401 of the electronic device 101 may display payment card and amount information on the display. For example, in the electronic device 101, the accessory electronic device 201 may be configured as a user authentication means for an electronic payment service.

The electronic payment app 401 of the electronic device 101 may request user authentication for electronic payment from the device manager 402 for user authentication. The device manager 402 may request user authentication from the accessory electronic device 201 paired with the electronic device.

The accessory electronic device 201 may perform a configured user authentication procedure (e.g., obtaining fingerprint information). The accessory electronic device 201 may transmit user authentication information to the electronic device 101.

If user authentication is successful based on the user authentication information transmitted from the accessory electronic device 201, the device manager 402 of the electronic device 101 may transmit authentication completion information to the electronic payment app 401 of the electronic device 101.

The electronic payment app 401 of the electronic device 101 may transmit payment completion information according to the success of user authentication to the app server 410. The app server 410 may transmit the payment completion information to the pay gateway 420, and the pay gateway 420 may transmit it to the store server 430 to complete the payment for the online purchase.

FIGS. 5A and 5B illustrate a method of configuring an accessory electronic device as an authentication means for an electronic payment service of an electronic device according to various embodiments of the disclosure.

The operations in FIGS. 5A and 5B are performed through the interaction of a processor and memory, and may be operated through a software module (e.g., configurations implemented on a framework) implemented in relation to each operation. For example, the software structure of the electronic device 101 may include an electronic payment application (hereinafter, electronic payment app 401) and/or a device manager 402 of the electronic device 101. The electronic payment app 401 and the device manager 402 may operate under the control of the processor 120 of the electronic device 101.

According to an embodiment, the electronic device 101 may initiate a registration procedure to register an accessory electronic device 201 as an authentication means through an electronic payment service (e.g., an electronic payment app). Although not illustrated in the drawings, the accessory electronic device 201 may be a device authenticated through pairing so as to communicate with the electronic device 101.

According to an embodiment, the accessory electronic device 201 may detect whether the accessory electronic device 201 is worn or removed and, based on detection of a wearing state, may be connected to the authenticated electronic device 101 via short-range communication (e.g., Bluetooth communication). The electronic device 101 may perform the authentication registration procedures for FIGS. 5A and 5B whenever the registered accessory electronic device 201 is connected via short-range communication.

### Embodiment 1

Referring to FIG. 5A, in operation 510, a pay app 401 of the electronic device 101 may request an authentication registration request to the device manager (e.g., ring manager) 402 in order to use the accessory electronic device 201 as an authentication means for an electronic payment service.

In operation 511, the device manager 402 of the electronic device 101 may transmit the authentication registration request to the accessory electronic device 201 connected to the electronic device 101.

In operation 512, the accessory electronic device 201 may identify whether the accessory electronic device 201 is worn and notify the electronic device 101 of wearing state information based on the accessory electronic device 201 being worn. For example, the accessory electronic device 201 may detect whether the accessory electronic device 201 is worn or not based on at least one sensor (e.g., the biometric sensor 250 or the temperature sensor 280 in FIG. 2).

For example, when the accessory electronic device 201 is configured as an authentication means for the electronic payment service of the electronic device 101, it may be implemented to perform an authentication token generation/update procedure depending on whether the accessory electronic device 201 is worn or removed.

As another example, the device manager 402 of the electronic device 101 may request wearing/removal information from the accessory electronic device 201 and receive the wearing/removal information of the accessory electronic device 201 in response to the request signal.

In operation 513, the device manager 402 of the electronic device 101 may generate an authentication token (e.g., first authentication token, 0x01) based on detecting that the accessory electronic device 201 is worn.

In operation 514, the device manager 402 of the electronic device 101 may transmit the generated authentication token (e.g., first authentication token, 0x01) to the accessory electronic device 201 via a communication module (e.g., the communication module 190 in FIG. 1 or the communication module 235 in FIG. 2).

In operation 515, the accessory electronic device 201 may store the first authentication token (e.g., 0x01) transmitted from the electronic device 101 in the accessory electronic device memory (e.g., the memory 220 in FIG. 2).

In operation 516, independently or in parallel with operation 514, the device manager 402 of the electronic device 101 may transmit the generated first authentication token (e.g., 0x01) to the electronic payment app 401.

In operation 517, the electronic payment app 401 of the electronic device 101 may store the first authentication token (e.g., 0x01) transmitted from the device manager 402 in the memory (e.g., the memory 130 in FIG. 1) of the electronic device 101.

According to an embodiment, when the accessory electronic device 201 switches to a removal state, operations 518 through 521 may be performed.

In operation 518, based on the accessory electronic device 201 having switched to a removal state, the accessory electronic device 201 may transmit removal state information to the device manager 402 of the electronic device 101 via the communication module.

In operation 519, the device manager 402 of the electronic device 101 may generate a second authentication token (e.g., 0x02), based on the removal state information of the accessory electronic device 201, and update the first authentication token to the second authentication token (e.g., 0x02).

In operation 520, the device manager 402 of the electronic device 101 may transmit the updated second authentication token (e.g., 0x02) to the accessory electronic device 201 via the communication module.

In operation 521, the accessory electronic device 201, based on the second authentication token (e.g., 0x02) transmitted from the electronic device 101, may update the first authentication token stored in the memory (e.g., the accessory electronic device memory 220) to the second authentication token (e.g., 0x02).

### Embodiment 2

Referring to FIG. 5B, in operation 550, the electronic payment app 401 of the electronic device 101 may request an authentication registration request to the device manager (e.g., ring manager) 402 of the electronic device 101 in order to use the accessory electronic device 201 as an authentication means for an electronic payment service.

In operation 551, the device manager 402 of the electronic device 101 may transmit the authentication registration request to a device manager 403 of the accessory electronic device 201 connected to the electronic device 101. For example, the device manager 403 of the accessory electronic device 201 may be installed on the accessory electronic device 201 as a software module for compatibility and connection between the accessory electronic device 201 and another electronic device (e.g., the electronic device 101 in FIG. 1).

In operation 552, the device manager 403 of the accessory electronic device 201 may detect whether the accessory electronic device 201 is worn or not and identify that the accessory electronic device 201 is worn. For example, the accessory electronic device 201 may detect whether the accessory electronic device 201 is worn or not based on at least one sensor (e.g., the biometric sensor 250 or the temperature sensor 280 in FIG. 2).

In operation 553, the device manager 403 of the accessory electronic device 201 may generate a first authentication token (e.g., 0x01) based on detecting that the accessory electronic device 201 is worn.

In operation 554, the device manager 403 of the accessory electronic device 201 may store the generated first authentication token (e.g., 0x01) in the memory (e.g., the memory 220 of the accessory electronic device 201 in FIG. 2).

In operation 555, the device manager 403 of the accessory electronic device 201 may transmit the generated first authentication token (e.g., 0x01) to the device manager 402 of the electronic device 101.

In operation 556, the device manager 402 of the electronic device 101 may transmit the first authentication token (e.g., 0x01) transmitted from the accessory electronic device 201 to the electronic payment app 401.

According to another embodiment, the device manager 402 of the electronic device 101 may store the first authentication token within the device manager 201 without transmitting it to the electronic payment app 401.

In operation 557, the electronic payment app 401 of the electronic device 101 may store the first authentication token (e.g., 0x01) transmitted from the device manager 402 in the memory (e.g., the memory 130 in FIG. 1).

According to an embodiment, when the accessory electronic device 201 switches to a removal state, operations 558 through 560 may be performed.

In operation 558, the device manager 403 of the accessory electronic device 201 may identify a removal state of the accessory electronic device 201.

In operation 559, the device manager 403 of the accessory electronic device 201 may generate a second authentication token (e.g., 0x02) based on the accessory electronic device 201 having switched to the removal state.

In operation 560, the device manager 403 of the accessory electronic device 201, based on the second authentication token (e.g., 0x02), may update the first authentication token stored in the memory (e.g., the accessory electronic device memory 220) to the second authentication token (e.g., 0x02).

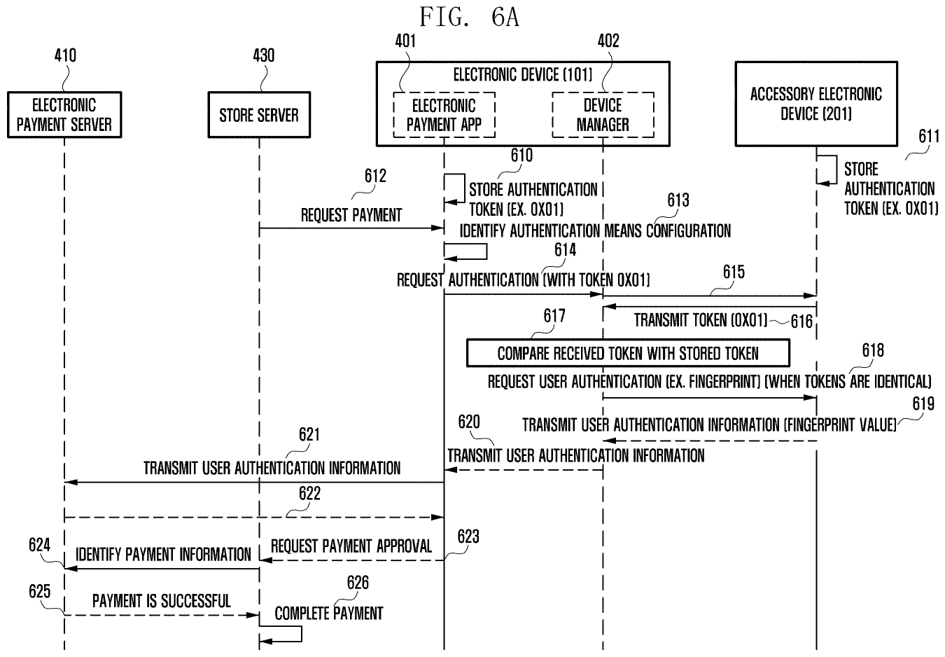

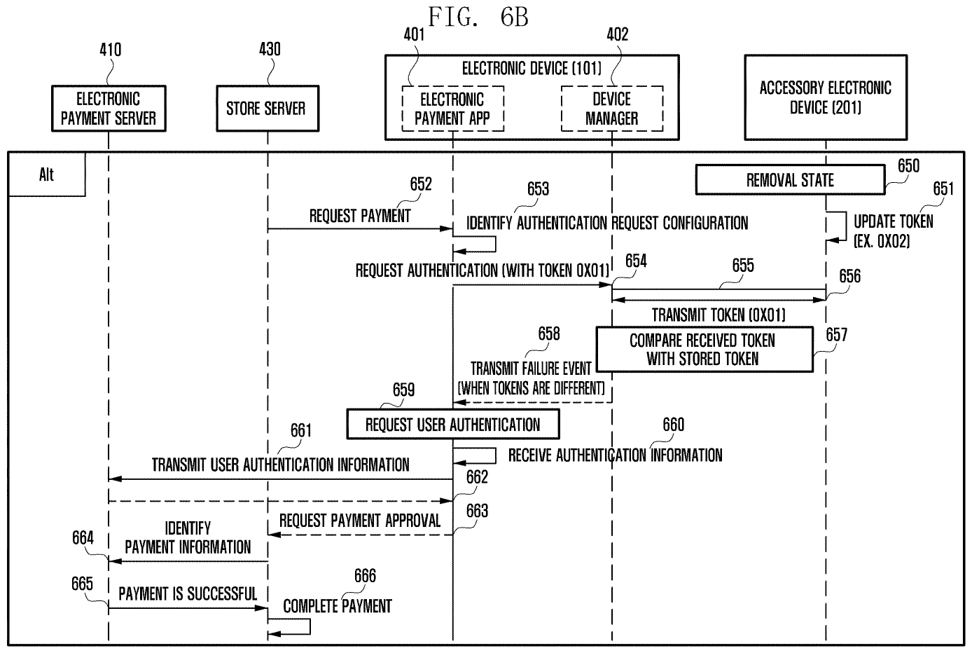

FIGS. 6A and 6B illustrate an electronic payment authentication service method for an electronic device using an accessory electronic device according to various embodiments of the disclosure.

The embodiment in FIGS. 6A and 6B may represent an example in which the electronic device 101 acts as the entity comparing the authentication tokens.

Referring to FIGS. 6A and 6B, in operation 610, the electronic payment app 401 of the electronic device 101 may perform the operations in FIGS. 5A and 5B to have the authentication token (e.g., first authentication token, 0x01) stored. In operation 611, the accessory electronic device 201 may also perform the operations in FIGS. 5A and 5B to have the authentication token (e.g., first authentication token, 0x01) stored.

As illustrated in FIG. 6A, in describing the payment process when the accessory electronic device 201 is in a wearing state, in operation 612, the store server 430 (and store app) may request a payment request for the purchase of goods selected on the electronic device to the electronic payment app 401 of the electronic device 101.

In operation 613, the electronic payment app 401 of the electronic device 101 may identify whether an authentication means (e.g., accessory electronic device authentication) is configured for the payment request.

In operation 614, in the case where an external device (e.g., the accessory electronic device 201) is configured as an authentication means, the electronic payment app 401 of the electronic device 101 may transmit an authentication request (e.g., user authentication request) to the device manager 402. The user authentication request may be transmitted along with an authentication token (e.g., first authentication token, 0x01) stored in the electronic payment app 401 of the electronic device 101.

In operation 615, the device manager 402 of the electronic device 101 may transmit the authentication request to the accessory electronic device 201.

In operation 616, in response to the authentication request from the electronic device 101, the accessory electronic device 201 may transmit an authentication token (e.g., second authentication token, 0x01) stored in the accessory electronic device 201 to the device manager 402 of the electronic device 101 via a communication module.

In operation 617, the device manager 402 of the electronic device 101 may compare the authentication token (e.g., second authentication token, 0x01) received from the accessory electronic device 201 with the authentication token (e.g., first authentication token, 0x01) stored in the electronic payment app 401 of the electronic device 101.

In operation 618, when the authentication token (e.g., first authentication token, 0x01) stored in the electronic payment app 401 of the electronic device is the same as the authentication token (e.g., second authentication token, 0x01) stored in the accessory electronic device, the device manager 402 of the electronic device 101 may request user authentication from the accessory electronic device 201.

For example, the accessory electronic device 201 may output an input alarm for the user authentication request (e.g., “There is a payment request. Please enter your fingerprint (or gesture, touch)”). The input alarm may be, for example, sound output, vibration, or LED lamp blinking, but is not limited thereto.

In operation 619, the accessory electronic device 201 may obtain user authentication information (e.g., fingerprint information or a fingerprint value) for the user input and transmit the recognized user authentication information (e.g., fingerprint information) to the device manager 402 of the electronic device 101.

For example, the user authentication for electronic payment may be specified as user-identifiable biometric information (e.g., fingerprint, blood flow, hand wrinkles, or PPG signal), as well as touch gestures or motion actions.

In operation 620, the device manager 402 of the electronic device 101 may transmit the user authentication information to the electronic payment app 401.

In operation 621, the electronic payment app 401 of the electronic device 101 may transmit the user authentication information to the electronic payment server 410.

For example, the electronic payment server 410 may determine whether authentication is successful by comparing the user authentication information transmitted from the electronic device 101 with pre-stored user authentication information of the electronic device 101.

In operation 622, when user authentication is successful, the electronic payment server 410 may transmit user authentication success information to the electronic payment app 401.

According to some embodiments, operations 621 and 622 may be performed in the electronic payment app 401.

In operation 623, the electronic payment app 401 of the electronic device 101, based on the success of user authentication, may transmit a payment approval request for the purchase of goods to the store server 430 (e.g., store app).

In operation 624, the store server 430 may transmit payment information for the payment approval to the electronic payment server 410 to request confirmation.

In operation 625, the electronic payment server 410 may transmit payment success information for the payment approval in the electronic payment app 401 of the electronic device to the store server 430.

In operation 626, the store server 430 may perform payment completion, based on the payment success information transmitted from the electronic payment server 410.

As illustrated in FIG. 6B, in describing the payment process when the accessory electronic device 201 is in a removal state, in operation 650, the accessory electronic device 201 may detect the removal state of the accessory electronic device 201. In operation 651, the authentication token stored in the memory of the accessory electronic device 201 may be updated (e.g., second authentication token, 0x02) based on the removal state of the accessory electronic device 201. For example, in operation, the accessory electronic device 201 may also perform the operations in FIGS. 5A and 5B so that the authentication token may be updated (e.g., second authentication token, 0x02).

In operation 652, the store server 430 (and the store app) may request a payment request for the purchase of goods selected on the electronic device 101 to the electronic payment app 401 of the electronic device 101.

In operation 653, the electronic payment app 401 of the electronic device 101 may identify whether an authentication means (e.g., accessory electronic device 201 authentication) is configured for the payment request.

In operation 654, in the case where an external device (e.g., the accessory electronic device 201) is configured as an authentication means, the electronic payment app 401 of the electronic device 101 may transmit an authentication request (e.g., user authentication) to the device manager 402. The user authentication request may be transmitted along with an authentication token (e.g., first authentication token, 0x01) stored in the electronic payment app 401 of the electronic device 101.

In operation 655, the device manager 402 of the electronic device 101 may transmit the authentication request to the accessory electronic device 201.

In operation 656, in response to the authentication request from the electronic device 101, the accessory electronic device 201 may transmit an authentication token (e.g., second authentication token, 0x02) stored in the accessory electronic device 201 to the device manager 402 of the electronic device 101 via a communication module.

In operation 657, the device manager 402 of the electronic device 101 may compare the authentication token (e.g., second authentication token, 0x02) received from the accessory electronic device 201 with the authentication token (e.g., first authentication token, 0x01) received from the electronic payment app 401 of the electronic device 101.

In operation 658, when the authentication token (e.g., first authentication token, 0x01) received from the electronic payment app 401 of the electronic device 101 is different from the authentication token (e.g., second authentication token, 0x02) received from the accessory electronic device, the device manager 402 of the electronic device 101 may transmit a failure event to the electronic payment app 401.

In operation 659, the electronic payment app 401 of the electronic device 101, in response to the failure event, may display a user authentication request using the electronic payment app 401 on the display. For example, the electronic payment app 401 may display a UI screen for inputting a configured user authentication (e.g., fingerprint, iris, or pattern) on the display.

In operation 660, the electronic payment app 401 of the electronic device 101 may receive user authentication information. The user authentication information refers to configured user authentication information, for example, it may refer to fingerprint information when user authentication is configured as a fingerprint.

In operation 661, the electronic payment app 401 of the electronic device 101 may transmit the recognized user authentication information (e.g., fingerprint information) to the electronic payment server 410. The electronic payment server 410 may determine whether authentication is successful by comparing the user authentication information transmitted from the electronic device 101 with user authentication information stored in the electronic device 101.

In operation 662, if user authentication is successful, the electronic payment server 410 may transmit user authentication success information to the electronic payment app 401.

According to some embodiments, operations 661 and 662 may be performed in the electronic payment app 401.

In operation 663, the electronic payment app 401 of the electronic device 101 may transmit a payment approval request for the purchase of goods to the store server 430 (e.g., store app) based on the success of user authentication.

In operation 664, the store server 430 may transmit payment information for the payment approval to the electronic payment server 410 to request confirmation.

In operation 665, the electronic payment server 410 may transmit payment success information for the payment approval in the electronic payment app 401 of the electronic device to the store server 430.

In operation 666, the store server 430 may perform payment completion, based on the payment success information transmitted from the electronic payment server 410.

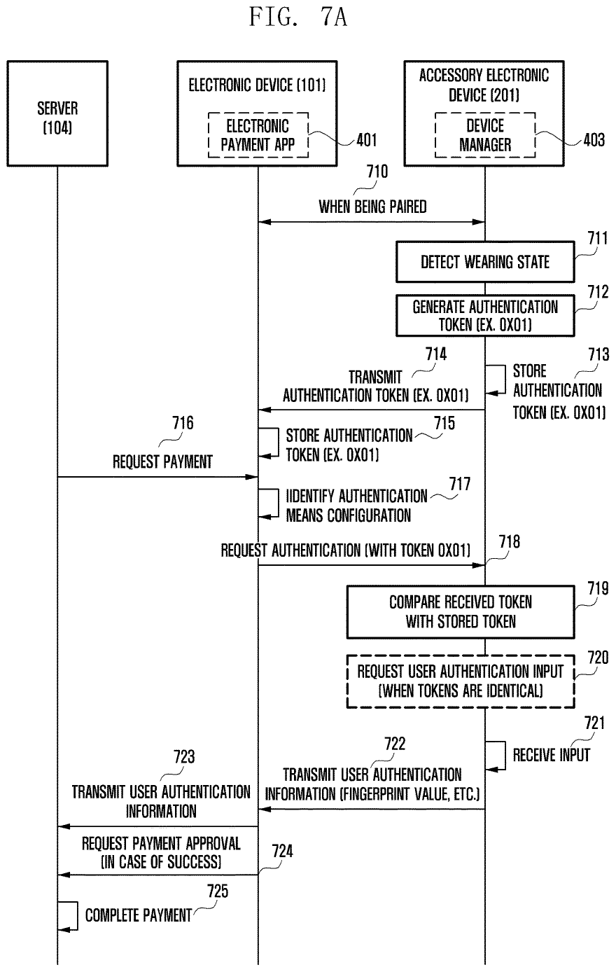

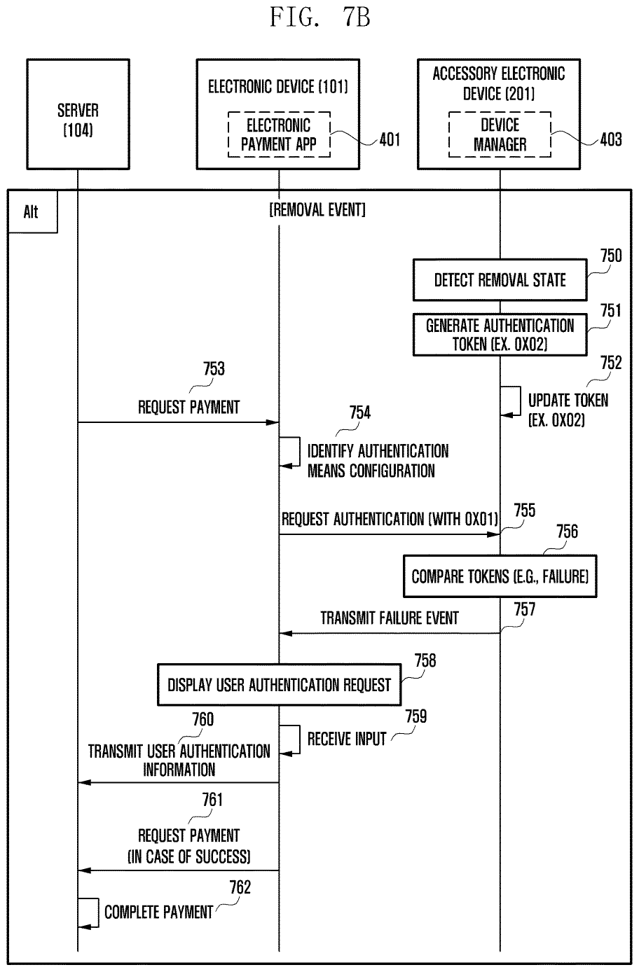

FIGS. 7A and 7B illustrate an electronic payment authentication service method for an electronic device using an accessory electronic device according to various embodiments of the disclosure.

The embodiment in FIGS. 7A and 7B may represent an example in which the accessory electronic device 201 acts as the entity comparing the authentication tokens. FIGS. 7A and 7B illustrate that the accessory electronic device 201 includes a device manager 403, but the electronic device 101 may include a device manager (e.g., the device manager 402 in FIG. 4), and the electronic payment app 401 and the accessory electronic device 201 may exchange signals/data through the device manager of the electronic device 101.

Referring to FIGS. 7A and 7B, in operation 710, the electronic device 101 and the accessory electronic device 201 may be in a paired state. The accessory electronic device 201 may refer to an electronic device that is pre-registered with the electronic device 101 as an authentication means during the electronic payment service.

As illustrated in FIG. 7A, in describing the payment process when the accessory electronic device 201 is in a wearing state, in operation 711, the device manager 403 of the accessory electronic device 201 may detect the wearing state of the accessory electronic device 201.

In operation 712, the device manager 403 of the accessory electronic device 201 may generate an authentication token (e.g., second authentication token, 0x01) based on the detection of the wearing state.

In operation 713, the device manager 403 of the accessory electronic device 201 may store the generated authentication token in the memory (e.g., the memory 220 in FIG. 2).

In operation 714, the device manager 403 of the accessory electronic device 201 may transmit the generated authentication token (e.g., first authentication token, 0x01) to the electronic device 101.

In operation 715, the electronic device 101 or the electronic payment app 401 may store the authentication token (e.g., first authentication token, 0x01) transmitted from the accessory electronic device 201 in the memory (e.g., the memory 130 in FIG. 1).

In operation 716, the electronic payment app 401 of the electronic device 101 may receive a payment request for online purchased goods from the server 104 via a communication module.

Although the server 104 is depicted as a single integrated form in FIGS. 7A and 7B, the server 104 may have a structure in which the electronic payment server 410 and the store server 430 are separated, as shown in FIGS. 6A and 6B. According to another embodiment, the payment request may be transmitted to the electronic payment app through the store server 430.

In operation 717, the electronic payment app 401 of the electronic device 101 may identify whether an authentication means (e.g., accessory electronic device 201 authentication) is configured for the payment request.

In operation 718, in the case where an external device (e.g., the accessory electronic device 201) is configured as an authentication means, the electronic payment app 401 of the electronic device 101 may transmit a user authentication request (e.g., user authentication request) to the accessory electronic device 201. The user authentication request may be transmitted along with the authentication token (e.g., first authentication token, 0x01) stored in the electronic payment app 401 of the electronic device 101.

In operation 719, the accessory electronic device 201 may compare the authentication token (e.g., first authentication token, 0x01) received from the electronic device 101 with the authentication token (e.g., second authentication token, 0x01) stored in the accessory electronic device 201.

In operation 720, when the authentication token (e.g., first authentication token, 0x01) received from the electronic device 101 and the authentication token (e.g., second authentication token, 0x01) stored in the accessory electronic device 201 are identical, the accessory electronic device 201 may request user authentication input.

In some embodiments, operation 720 may be omitted.

In operation 721, the accessory electronic device 201 may receive (or obtain) user authentication information (e.g., fingerprint information or a fingerprint value) about a user input.

In operation 722, the accessory electronic device 201 may transmit the recognized user authentication information (e.g., fingerprint information) to the electronic device 101 or the electronic payment app 401.

In operation 723, the electronic payment app 401 of the electronic device 101 may transmit the user authentication information transmitted from the accessory electronic device 201 to the server 104 (e.g., the electronic payment server 410). For example, the server 104 (e.g., the electronic payment server 410) may determine whether authentication is successful by comparing the user authentication information transmitted from the electronic device 101 with user authentication information stored in the electronic device 101.

As another example, operation 723 may be omitted, and the electronic payment app 401 may determine whether authentication is successful by comparing the user authentication information transmitted from the accessory electronic device 201 with user authentication information pre-stored in the electronic device 101.

In operation 724, the electronic payment app 401 of the electronic device 101, based on the success of user authentication, may transmit payment approval for the payment request to the server 104.

In operation 725, the server 104 may perform payment completion based on the payment approval.

According to another embodiment, in the case where the server 104 includes the electronic payment server 410 and the store server 430 as shown in FIG. 6A, operations 723 through 725 may be replaced by operations 621 through 626.

As illustrated in FIG. 7B, in describing the payment process when the accessory electronic device 201 is in a removal state, in operation 750, the device manager 403 of the accessory electronic device 201 may detect the removal state of the accessory electronic device 201.

In operation 751, the device manager 403 of the accessory electronic device 201 may generate a new authentication token (e.g., second authentication token, 0x02) based on the detection of the removal state.

In operation 752, the device manager 403 of the accessory electronic device 201 may update the authentication token stored in the memory (e.g., the memory 220 in FIG. 2) with the newly generated authentication token (e.g., second authentication token, 0x01→0x02).

In operation 753, the electronic payment app 401 of the electronic device 101 may receive a payment request for online purchased goods from the server 104 via a communication module.

In operation 754, the electronic payment app 401 of the electronic device 101 may identify whether an authentication means (e.g., accessory electronic device authentication) is configured for the payment request.

In operation 755, in the case where an external device (e.g., the accessory electronic device 201) is configured as an authentication means, the electronic payment app 401 of the electronic device 101 may transmit a user authentication request (e.g., user authentication request) to the accessory electronic device 201. The user authentication request may be transmitted along with the authentication token (e.g., first authentication token, 0x01) stored in the electronic payment app 401 of the electronic device 101.

In operation 756, the accessory electronic device 201 may compare the authentication token (e.g., first authentication token, 0x01) received from the electronic device 101 with the authentication token (e.g., second authentication token, 0x02) stored in the accessory electronic device 201.

In operation 757, when the authentication token (e.g., first authentication token, 0x01) received from the electronic device 101 and the authentication token (e.g., second authentication token, 0x02) stored in the accessory electronic device 201 are different, the accessory electronic device 201 may transmit a failure event to the electronic device 101 or the electronic payment app 401 via the communication module.

In operation 758, the electronic payment app 401 of the electronic device 101, in response to the failure event, may display a user authentication request using the electronic payment app 401 on the display. For example, the electronic payment app 401 may display a UI screen for inputting a configured user authentication (e.g., fingerprint, iris, or pattern) on the display.

In operation 759, the electronic payment app 401 of the electronic device 101 may receive (or obtain) user authentication information (e.g., fingerprint information or a fingerprint value) for a user input.

In operation 760, the electronic payment app 401 of the electronic device 101 may transmit the user authentication information authenticated through the electronic device 101 to the server 104 (e.g., the electronic payment server 410). For example, the server 104 (e.g., the electronic payment server 410) may determine whether authentication is successful by comparing the user authentication information transmitted from the electronic device 101 with user authentication information stored in the electronic device 101.

As another example, operation 760 may be omitted, in which case the electronic payment app 401 may determine whether authentication is successful by comparing the input user authentication information with user authentication information stored in the electronic device 101.

In operation 761, based on the success of user authentication, the electronic payment app 401 of the electronic device 101 may transmit payment approval for the payment request to the server 104.

In operation 762, the server 104 may perform payment completion based on the payment approval.

According to another embodiment, in the case where the server 104 includes the electronic payment server 410 and the store server 430 as shown in FIG. 6B, operations 760 through 762 may be replaced with operations 661 through 666.

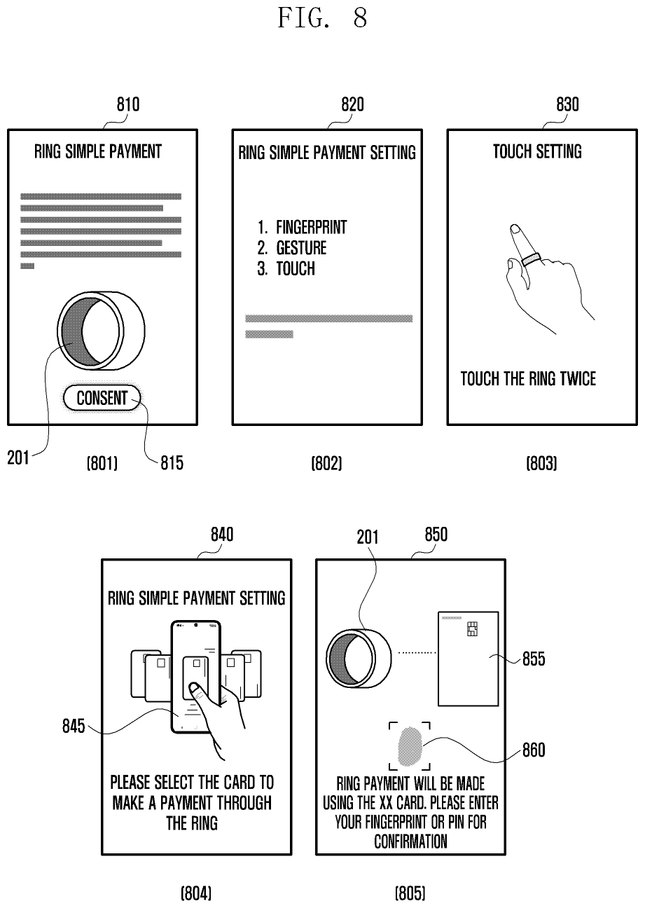

FIG. 8 illustrates an example of an authentication means configuration screen related to an electronic payment service for an electronic device according to an embodiment of the disclosure.

Referring to FIG. 8, an electronic device 101 according to an embodiment may support an offline simple payment (e.g., electronic payment) service function using an external electronic device.

According to an embodiment, the electronic device 101 may display, on a display (e.g., the display module 160 in FIG. 1), a first UI screen 810 to confirm user consent for using an accessory electronic device 201 as a user authentication means during a simple payment service, as illustrated in <801>. The first UI screen 810 may include guidance information regarding simple payment and a consent item 815 for configuration. When the user selects the consent item 815, the electronic device 101 may display a second UI screen 820 for configuring authentication input items in the accessory electronic device 201, as illustrated in <802>. The second UI screen 820 may include items for fingerprint, gesture, or touch configuration as user authentication input using the accessory electronic device 201. User input is merely an example and is not limited to the examples in the second UI screen 820. For example, when the user selects touch configuration in the second UI screen 820, the electronic device 101 may display a third UI screen 830 for configuring touch input as user authentication, as illustrated in <803>. After the touch input configuration is completed, the electronic device 101 may display a fourth UI screen 840 for selecting a card to be used for simple payment, as illustrated in <804>. The user may select a card 850 to be used for simple payment from among the cards registered in the electronic device 101 through the fourth UI screen 840. As illustrated in <805>, when the user authentication is completed based on the accessory electronic device 201, the electronic device 101 may display a fifth UI screen 850 that provides guidance information for proceeding with electronic payment using the selected card 855 and requests an approval input (e.g., fingerprint input item 860). When the user performs fingerprint authentication on the fifth UI screen 850, user authentication may be performed based on the user authentication information entered in the accessory electronic device 201 during simple payment.

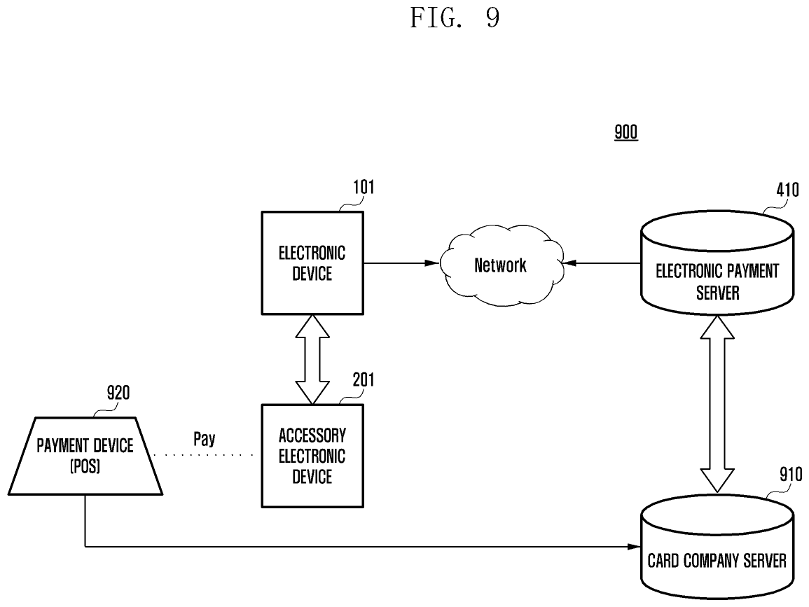

FIG. 9 is a view illustrating an offline payment system using an electronic device and an accessory electronic device according to an embodiment of the disclosure.

Referring to FIG. 9, an offline payment system 900 using an accessory electronic device as an authentication means according to an embodiment may include an electronic device 101, an accessory electronic device 201, an app server 410, a card company server 910, and a payment device 920 (e.g., a point of sale (POS) device) in an offline store.

The accessory electronic device 201 may enter an electronic payment mode, based on detecting a pre-configured gesture for electronic payment. The accessory electronic device 201 may request payment card information and token information for payment from the electronic device 101. The accessory electronic device 201 may receive payment card information and token information from the electronic device 101. The accessory electronic device 201 may emit a payment request signal containing the received payment card information and token information to the outside through a short-range communication module (e.g., NFC or MST communication). The payment device 920 may proceed with payment completion, based on a payment request signal received from the outside via the short-range communication module.

The payment device 920 may transmit payment completion approval information to the card company server 910. The card company server 910 may transmit the payment completion approval information to the electronic payment server 410 (e.g., Samsung Pay server or Naver Pay server) that provides electronic payment services. The electronic payment server 410 may transmit the payment completion approval information to the electronic device 101. The electronic device 101 may inform/notify the user of information regarding the electronic payment approval.

According to an embodiment, the electronic device 101 may also transmit information regarding whether the payment has been completed to the accessory electronic device 201. For example, the electronic device 101 may output information regarding payment success or payment failure to the display of the electronic device 101, or may transmit information regarding payment success or payment failure to the accessory electronic device 201 to provide a notification of payment success or failure through the accessory electronic device 201.

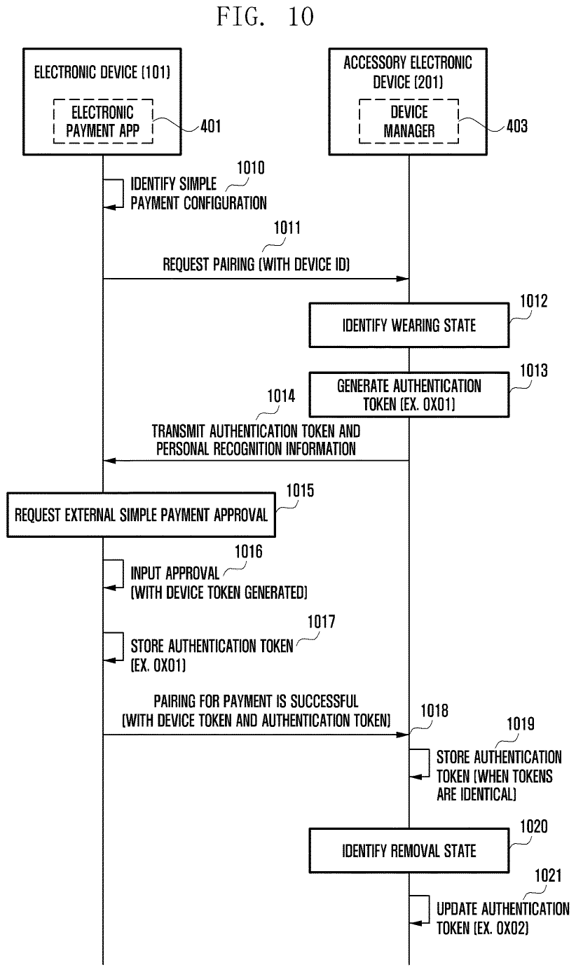

According to an embodiment, the electronic device 101 may perform a registration procedure to register the accessory electronic device 201 as a payment means (or authentication means) during offline or online electronic payment through the operations shown in FIG. 10.

FIG. 10 illustrates a method of configuring an accessory electronic device as an authentication and payment means for an electronic payment service of an electronic device according to an embodiment of the disclosure.

Referring to FIG. 10, according to an embodiment, the electronic payment app 401 of the electronic device 101 may identify that an external simple payment is configured in relation to the electronic payment service in operation 1010. For example, the user may proceed with simple payment configuration using an external electronic device (e.g., the accessory electronic device 201) through the UI screens illustrated in FIG. 8.

In operation 1011, the electronic payment app 401 of the electronic device 101 may transmit a pairing request, including identification information (e.g., electronic device ID) of the electronic device 101, to the device manager 403 of the accessory electronic device 201 via a communication module.

The accessory electronic device 201 may identify whether the electronic device 101 is a registered one based on the identification information of the electronic device 101. For example, the identification information of the electronic device 101 may refer to a unique value generated during the initial connection establishment between the electronic device 101 and the accessory electronic device 201. The electronic device 101 and the accessory electronic device 201 may each be configured to store device identification information (e.g., electronic device ID and accessory device ID) during the initial connection establishment, and exchange the device identification information during pairing connection and, if the device identification information is different, reperform the initial registration procedure without performing the pairing procedure.

As another example, the electronic device 101 may identify whether the electronic device 101 is a registered one that has a record of being paired with the accessory electronic device 201.

In operation 1012, the device manager 403 of the accessory electronic device 201 may identify whether the accessory electronic device 201 is worn or not, and detect that the accessory electronic device 201 is in a wearing state. For example, the accessory electronic device 201 may detect whether it is worn or not based on at least one sensor (e.g., the biometric sensor 250 or the temperature sensor 280 in FIG. 2).

In operation 1013, the device manager 403 of the accessory electronic device 201 may generate an authentication token (e.g., second authentication token, 0x01) based on detecting that the accessory electronic device 201 is worn.

In operation 1014, the device manager 403 of the accessory electronic device 201 may transmit at least one of the generated authentication token and/or personal identification information (or personal recognition information) to the electronic payment app 401 of the electronic device 101 via a communication module.

The personal identification information may refer to a unique value generated to identify the user using the user's personal biometric information obtained from the accessory electronic device. The personal identification information may be generated based on biometric information, such as fingerprint information, blood flow, hand wrinkles, pulse, and skin temperature. In some cases, the personal identification information may be omitted.

In operation 1015, the electronic payment app 401 of the electronic device 101 may request a simple payment approval input using the accessory electronic device 201. For example, the user may perform authentication input configuration, card selection, and approval input based on the screen UIs in FIG. 8.

In operation 1016, the electronic payment app 401 of the electronic device 101 may generate a device token for pairing connection in the approval input.

In operation 1017, the electronic payment app 401 of the electronic device 101 may store an authentication token (e.g., first authentication token, 0x01) transmitted from the accessory electronic device 201.

In operation 1018, the electronic payment app 401 of the electronic device 101 may transmit information on the successful pairing connection for payment, including the device token and the authentication token, to the accessory electronic device 201.

In operation 1019, if the authentication token generated during the pairing connection is the same as the authentication token transmitted from the electronic device, the device manager 403 of the accessory electronic device 201 may store the generated authentication token (e.g., second authentication token, 0x01).

In operation 1020, the device manager 403 of the accessory electronic device 201 may detect the removal state of the accessory electronic device 201.

In operation 1021, based on detecting the removal state based on the removal state information of the accessory electronic device 201, the device manager 403 of the accessory electronic device 201 may generate a new authentication token (e.g., 0x02) and update the authentication token stored in the memory (e.g., the memory 220 in FIG. 2) (e.g., second authentication token, 0x01→0x02).

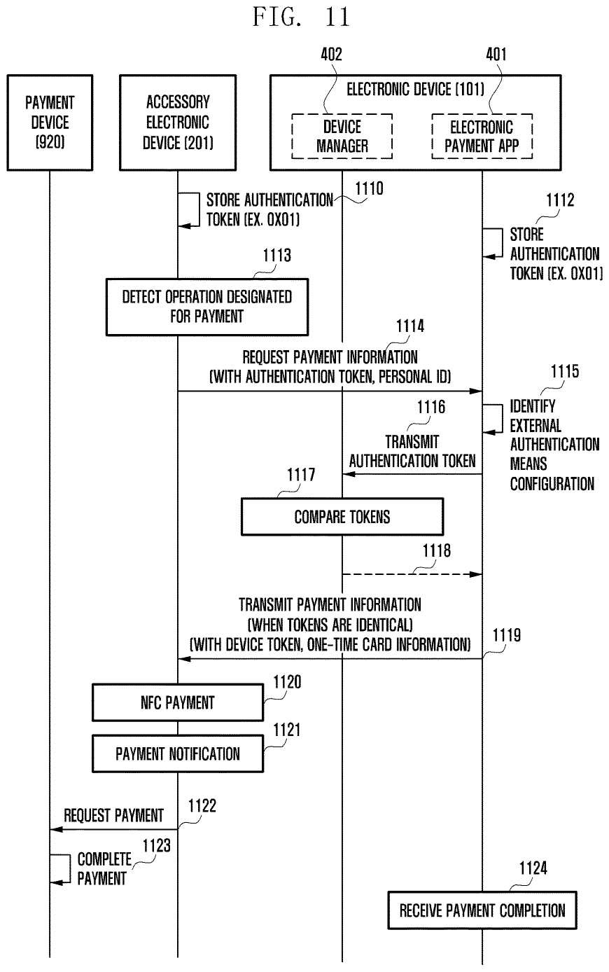

FIG. 11 illustrates an electronic payment service method of an electronic device using an accessory electronic device according to an embodiment of the disclosure.

Referring to FIG. 11, the accessory electronic device 201 according to an embodiment may support a function of performing user authentication for a simple payment during an offline simple payment service of the electronic device 101.

In operation 1110, the pay app 401 of the electronic device 101 may perform the operations in FIG. 10 so that an authentication token (e.g., first authentication token, 0x01) is stored. In operation 1112, the accessory electronic device 201 may also perform the operations in FIG. 10 so that an authentication token (e.g., second authentication token, 0x01) is stored.

In operation 1113, the accessory electronic device 201 may detect an operation designated for payment. For example, the electronic device may configure a gesture operation (e.g., double touch input) to enter the simple payment mode in FIG. 8.

In operation 1114, the accessory electronic device 201 may request payment information from the electronic payment app 401 of the electronic device via a communication module. For example, the payment information request may include the authentication token (e.g., second authentication token) and personal identification information stored in the accessory electronic device 201.

In operation 1115, in the case where an external device (e.g., the accessory electronic device 201) is configured as an authentication means, the electronic payment app 401 of the electronic device 101 may identify that the authentication means is configured using the device manager 402.

In operation 1116, the electronic payment app 401 of the electronic device 101 may transmit the authentication token (e.g., first authentication token, 0x01) stored in the electronic payment app to the device manager 402.

In operation 1117, the device manager 402 of the electronic device 101 may compare the authentication token (e.g., second authentication token, 0x01) received from the accessory electronic device 201 with the authentication token (e.g., first authentication token, 0x01) stored in the electronic payment app 401 of the electronic device 101.

In operation 1118, the device manager 402 of the electronic device 101 may transmit the result of comparing the authentication token (e.g., first authentication token, 0x01) stored in the electronic payment app of the electronic device with the authentication token (e.g., second authentication token, 0x01) stored in the accessory electronic device 201 to the electronic payment app 401.

In operation 1119, the electronic payment app 401 of the electronic device 101 may transmit payment information to the accessory electronic device, based on the authentication tokens being identical. The payment information may include, for example, a device token and one-time card information for payment.

In operation 1120, the accessory electronic device 201 may perform a payment using short-range communication (e.g., a tag for NFC or MST payment) based on the payment information transmitted from the electronic payment app 401 of the electronic device 101. A payment signal using short-range communication may be transmitted externally through a short-range communication module. For example, it may include a payment signal device token using short-range communication and one-time card information for payment.

In operation 1121, the accessory electronic device 201 may output a notification indicating that payment is in progress using short-range communication.

According to some embodiments, operation 1121 may be omitted.

In operation 1122, the accessory electronic device 201 may receive a payment signal using short-range communication.

In operation 1123, the payment device 1101 may complete payment approval based on the received payment signal using short-range communication.

In operation 1124, the electronic device 101 may receive payment completion information from the electronic payment server 410.

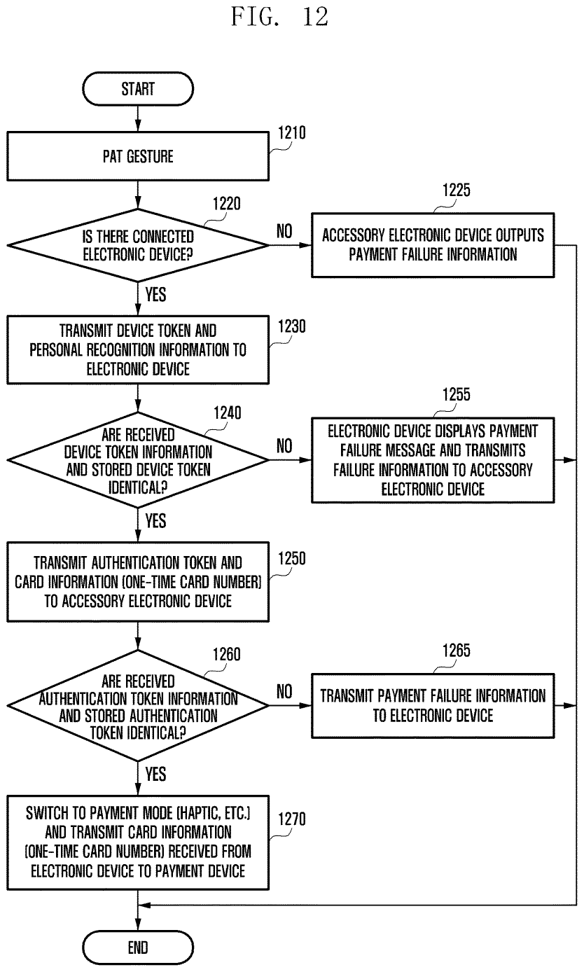

FIG. 12 illustrates an offline electronic payment service method of an electronic device using an accessory electronic device according to an embodiment of the disclosure.

Referring to FIG. 12, the accessory electronic device 201 according to an embodiment may detect a payment gesture operation designated for payment (e.g., a gesture operation while wearing the accessory electronic device) in operation 1210.

In operation 1220, the accessory electronic device 201 may determine whether there is an electronic device 101 connected (or paired) with the accessory electronic device 201.

In operation 1230, if there is an electronic device connected to the accessory electronic device 201 (Yes in operation 1220), the accessory electronic device 201 may transmit at least one of a device token and personal identification information to the electronic device 101 via a communication module. The device token may refer to a token value (or device identification information) exchanged between the electronic device 101 and the accessory electronic device 201 to identify the device when paired. The personal identification information may refer to a unique value generated to identify the user using the user's personal biometric information obtained from the accessory electronic device 201.

In operation 1225, if there is no electronic device 101 connected to the accessory electronic device 201 (No in operation 1220), the accessory electronic device 201 may output a notification of payment failure information (e.g., vibration or sound).

In operation 1240, the electronic device 101 may determine whether the device token transmitted from the accessory electronic device 201 is the same as the device token stored when paired with the accessory electronic device 201.

In operation 1250, if the device token transmitted from the accessory electronic device 201 and the device token stored in the electronic device 101 are the same (Yes in operation 1240), the electronic device 101 may transmit the authentication token (e.g., first authentication token) and card information for payment (e.g., one-time card number) stored in the electronic device 101 to the accessory electronic device 201.

In operation 1255, if the device token transmitted from the accessory electronic device 201 and the device token stored in the electronic device 101 are different (No in operation 1240), the electronic device 101 may display a payment failure message on the display and transmit payment failure information to the accessory electronic device 201.

In operation 1260, the accessory electronic device 201 may determine whether the authentication token (e.g., first authentication token) transmitted from the electronic device 101 and the authentication token (e.g., second authentication token) stored in the accessory electronic device 201 are the same.

In operation 1270, if the authentication token (e.g., first authentication token) transmitted from the electronic device 101 and the authentication token (e.g., second authentication token) stored in the accessory electronic device 201 are the same (Yes in operation 1260), the accessory electronic device 201 may switch to payment mode and transmit the card information received from the electronic device 101 to a payment device (e.g., a POS device).

In operation 1265, if the authentication token (e.g., first authentication token) transmitted from the electronic device 101 and the authentication token (e.g., second authentication token) stored in the accessory electronic device 201 are different (No in operation 1260), the accessory electronic device 201 may transmit a payment failure message to the electronic device 101.

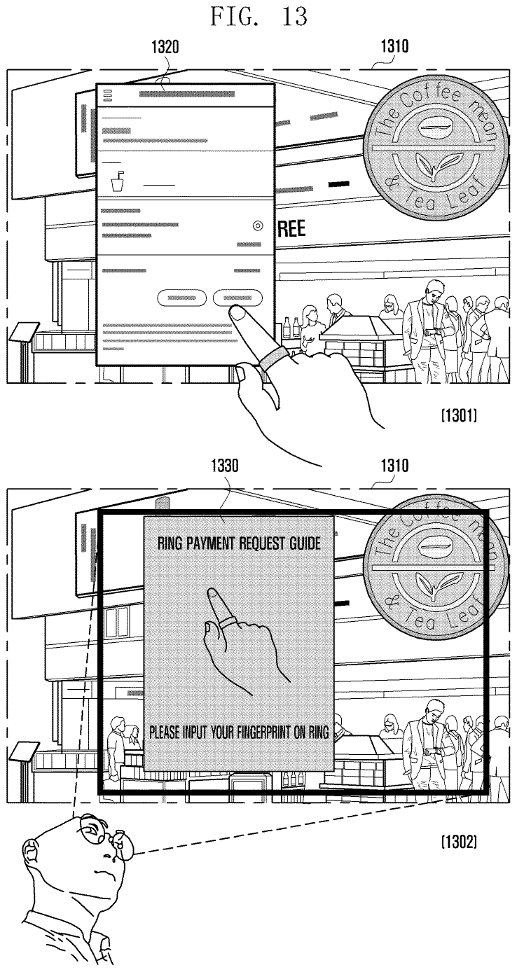

FIG. 13 illustrates an example of an electronic payment service method of an electronic device using an accessory electronic device according to an embodiment of the disclosure.

Referring to FIG. 13, the electronic device 101 according to an embodiment may be implemented as an electronic device 101 that supports extended reality (XR) content (e.g., augmented reality content). For example, the electronic device 101 may display an augmented reality image 1310 through a camera on a display as illustrated in <1301>. The electronic device 101 may display payment information 1320 for an offline store superimposed on the augmented reality image 1310. In the case where an accessory electronic device 201 is configured as an authentication means for electronic payment, the electronic device 101 may display request guide information 1330 guiding simple payment with the accessory electronic device 201 superimposed on the augmented reality image 1310, as shown in <1302>. The user may identify the request guide information 1330 and perform offline electronic payment using the accessory electronic device 201.

An electronic payment service method of an electronic device using an accessory electronic device according to an embodiment may include generating a first authentication token by the electronic device through a device manager associated with the accessory electronic device, based on detection of wearing of the accessory electronic device, when being paired with the accessory electronic device through a communication module. The method according to an embodiment may include transmitting the generated first authentication token to an electronic payment application. The method according to an embodiment may include, upon receiving an electronic payment service request from the electronic payment application, requesting an authentication token from the accessory electronic device to receive a second authentication token from the accessory electronic device or the device manager. The method according to an embodiment may include requesting user authentication for electronic payment from the accessory electronic device through the communication module in a case where the first authentication token stored in the electronic payment application is identical to the second authentication token transmitted from the accessory electronic device or the device manager. The method according to an embodiment may include determining whether user authentication is successful based on user authentication information received from the accessory electronic device.

The method according to an embodiment may further include generating a third authentication token based on detection of removal of the accessory electronic device through the device manager, and updating the first authentication token to the third authentication token.

The method according to an embodiment may further include displaying authentication failure information on a display via the electronic payment application in a case where the first authentication token stored in the electronic payment application differs from the second authentication token transmitted from the device manager.

The method according to an embodiment may include, after receiving the second authentication token, in a case where the first authentication token stored in the electronic payment application differs from the second authentication token transmitted from the device manager, stopping the user authentication requested to the accessory electronic device and requesting user authentication through the electronic payment application.

According to an embodiment, in a case where the device manager is programmed to the memory of the electronic device, the transmitting of the first authentication token to the electronic payment application may further include transmitting the first authentication token to the electronic payment application and the accessory electronic device, and comparing the first authentication token with the second authentication token through the electronic payment application or the device manager to determine whether they are identical.

The method according to an embodiment may further include, in a case where the device manager is programmed to the memory of the accessory electronic device, receiving the first authentication token or the third authentication token generated through the device manager from the accessory electronic device via the communication module, and transmitting the first authentication token or the third authentication token transmitted from the accessory electronic device to the electronic payment application via the communication module.

According to an embodiment, the determining whether the user authentication is successful may further include proceeding with the electronic payment service in a case where the user authentication information transmitted from the accessory electronic device is identical to the user authentication information stored in the electronic device.

It should be appreciated that various embodiments of the disclosure and the terms used therein are not intended to limit the technological features set forth herein to particular embodiments and include various changes, equivalents, or replacements for a corresponding embodiment. In the disclosure, each of phrases, such as “A or B,” “at least one of A and B,” “at least one of A or B,” “A, B, or C,” “at least one of A, B, and C,” and “at least one of A, B, or C” may include any one of the items listed together in the corresponding phrase or all possible combinations of the items. Such terms as “a first”, “a second”, “the first”, and “the second” may be used to simply distinguish a corresponding element from another, and does not limit the elements in other aspect (e.g., importance or order). When a certain (e.g., a first) component is mentioned as being “coupled” or “connected” to another (e.g., a second) component, with or without a term “functionally” or “communicatively,” it means that the certain component may be connected to the other component directly (e.g., wiredly), wirelessly, or via a third component.

As used in connection with various embodiments of the disclosure, the term “module” may include a unit implemented in hardware, software, or firmware, and may interchangeably be used with other terms, for example, “logic,” “logic block,” “part,” or “circuitry”. The module may be an integrally configured component or a minimum unit or a portion of the component, which performs one or more functions. For example, according to an embodiment, the module may be implemented in the form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of a device (e.g., the electronic device 101) may invoke and execute at least one of the stored one or more instructions from the storage medium. This enables the device to be operated to perform at least one function in response to the at least one invoked instruction. The one or more instructions may include codes generated by a compiler or code capable of being executed by an interpreter. The machine-readable storage medium may be provided in the form of a non-transitory storage medium. Here, the term “non-transitory” merely means that the storage medium is a tangible device and does not contain a signal (e.g., electromagnetic waves), and this term is not intended to distinguish a case where data is permanently stored on the storage medium and a case where data is temporarily stored.

According to an embodiment, a method according to various embodiments of the disclosure may be included and provided in a computer program product. The computer program product may be traded as a product between a seller and a purchaser. The computer program product may be distributed in the form of a machine-readable storage medium (e.g., a compact disc read-only memory (CD-ROM)), or may be directly distributed through an application store (e.g., Play Store™) or directly between two user devices (e.g., smartphones), or may be distributed online (e.g., downloaded or uploaded). In the case of online distribution, at least part of the computer program product may be temporarily stored or produced in a machine-readable storage medium such as a manufacturer's server, a server of an application store, or the memory of a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively, or additionally, multiple components (e.g., modules or programs) may be integrated into a single component. In such a case, the integrated element may perform one or more functions of each of the plurality of elements in the same or similar manner as they are performed by a corresponding one of the plurality of elements before the integration. According to embodiments, operations performed by the module, the program, or another element may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication module comprising at least one communication circuit;
memory, comprising one or more storage media, storing instructions; and
one or more processors communicatively coupled to the communication module and the memory,
wherein the instructions, when executed by the one or more processors individually or collectively, cause the electronic device to:
based on receiving information on detection of wearing of an accessory electronic device registered in the memory through the communication module while the electronic device is paired with the accessory electronic device, generate a first authentication token through a device manager associated with the accessory electronic device, and transmit the generated first authentication token to an electronic payment application stored in the memory,
upon receiving an electronic payment service request from the electronic payment application, request an authentication token from the accessory electronic device to receive a second authentication token from either the accessory electronic device or the device manager,
in a case where the first authentication token stored in the electronic payment application is identical to the second authentication token transmitted from either the accessory electronic device or the device manager, request user authentication for electronic payment from the accessory electronic device, and
determine whether user authentication is successful based on user authentication information received from the accessory electronic device.

2. The electronic device of claim 1, wherein the instructions, when executed by the one or more processors individually or collectively, further cause the electronic device to:
generate a third authentication token, based on receiving information on detection of removal of the accessory electronic device from the accessory electronic device, after storing the first authentication token in the memory; and
update the first authentication token to the third authentication token.

3. The electronic device of claim 1, wherein the instructions, when executed by the one or more processors individually or collectively, further cause the electronic device to:
display authentication failure information on a display via the electronic payment application in a case where the first authentication token stored in the electronic payment application differs from the second authentication token transmitted from the device manager.

4. The electronic device of claim 1, wherein the instructions, when executed by the one or more processors individually or collectively, further cause the electronic device to:
in a case where the first authentication token stored in the electronic payment application differs from the second authentication token transmitted from the device manager, stop the user authentication requested to the accessory electronic device and request user authentication using the electronic payment application.

5. The electronic device of claim 1, wherein the first authentication token and the second authentication token comprise at least one of token data, device identification information, and personal identification information.

6. The electronic device of claim 1, wherein the user authentication is one of biometric information or a password.

7. The electronic device of claim 1, wherein, in a case where the device manager is programmed to the memory of the electronic device, the instructions, when executed by the one or more processors individually or collectively, further cause the electronic device to:
transmit the first authentication token to the electronic payment application and the accessory electronic device; and
compare the first authentication token with the second authentication token through the electronic payment application or the device manager to determine whether they are identical.

8. The electronic device of claim 2, wherein, in a case where the device manager is programmed to the memory of the accessory electronic device, the instructions, when executed by the one or more processors individually or collectively, further cause the electronic device to:
receive the first authentication token or the third authentication token generated through the device manager from the accessory electronic device via the communication module; and
transmit the first authentication token or the third authentication token transmitted from the accessory electronic device to the electronic payment application via the communication module.

9. The electronic device of claim 1, wherein the instructions, when executed by the one or more processors individually or collectively, further cause the electronic device to:
proceed with the electronic payment service in a case where the user authentication information transmitted from the accessory electronic device is identical to the user authentication information stored in the electronic device.

10. An accessory electronic device comprising:
at least one sensor;
a communication module comprising at least one communication circuit;
memory, comprising one or more storage media, storing instructions; and
one or more processors communicatively coupled to the at least one sensor, the communication module, and the memory,
wherein the instructions, when executed by the one or more processors individually or collectively, cause the accessory electronic device to:
based on pairing with an electronic device through the communication module and detection of wearing of the accessory electronic device through the at least one sensor, generate a first authentication token, store the first authentication token in the memory, and transmit the first authentication token to the electronic device through the communication module,
upon receiving a second authentication token for an electronic payment request from the electronic device, provide a notification of user authentication request information for the electronic payment request, based on the first authentication token being identical to the second authentication token,
determine whether user authentication is successful based on user authentication information detected through the at least one sensor, and
transmit user authentication success information for the electronic payment request to the electronic device through the communication module in a case where user authentication is successful, or transmit user authentication failure information to the electronic device through the communication module in a case where user authentication fails.

11. A method for an electronic payment service of an electronic device using an accessory electronic device, the method comprising:
generating a first authentication token through a device manager associated with the accessory electronic device, based on pairing between the accessory electronic device and an electronic device and receiving information on detection of wearing of the accessory electronic device from the accessory electronic device;
transmitting the generated first authentication token to an electronic payment application;
upon receiving an electronic payment service request from the electronic payment application, requesting an authentication token from the accessory electronic device to receive a second authentication token from either the accessory electronic device or the device manager;
in a case where the first authentication token stored in the electronic payment application is identical to the second authentication token transmitted from either the accessory electronic device or the device manager, requesting user authentication for electronic payment from the accessory electronic device; and
determining whether user authentication is successful based on user authentication information received from the accessory electronic device.

12. The method of claim 11, further comprising:
generating a third authentication token, based on receiving information on detection of removal of the accessory electronic device from the accessory electronic device, after storing the first authentication token in memory of the electronic device; and
updating the first authentication token to the third authentication token.

13. The method of claim 11, further comprising:
displaying authentication failure information on a display via the electronic payment application in a case where the first authentication token stored in the electronic payment application differs from the second authentication token transmitted from the device manager.

14. The method of claim 11, further comprising:
in a case where the first authentication token stored in the electronic payment application differs from the second authentication token transmitted from the device manager, stopping the user authentication requested to the accessory electronic device and requesting user authentication through the electronic payment application.

15. The method of claim 11, wherein the first authentication token and the second authentication token comprise token data, device identification information, and personal identification information.

16. The method of claim 11, wherein the user authentication is one of biometric information or a password.

17. The method of claim 11, further comprising, in a case where the device manager is programmed to the memory of the electronic device:
transmitting the first authentication token to the electronic payment application and the accessory electronic device; and
comparing the first authentication token with the second authentication token through the electronic payment application or the device manager to determine whether they are identical.

18. The method of claim 12, further comprising, in a case where the device manager is programmed to the memory of the accessory electronic device:
receiving the first authentication token or the third authentication token generated through the device manager from the accessory electronic device via the communication module; and
transmitting the first authentication token or the third authentication token transmitted from the accessory electronic device to the electronic payment application via the communication module.

19. The method of claim 11, further comprising:
proceeding with the electronic payment service in a case where the user authentication information transmitted from the accessory electronic device is identical to the user authentication information stored in the electronic device.
